(19) United States
(12) Patent Application Publication
(10) Pub. No.: US 2024/0179481 A1
(43) Pub. Date: May 30, 2024

(54) SMALL MEANDER LINE ANTENNA FOR IN-THE-EAR HEARING DEVICE

(71) Applicant: Sonova AG, Stäfa (CH)

(72) Inventors: Munsoo Bae, Stäfa (CH); John Whitmore, Stäfa (CH); Andre Ochsenbein, Stäfa (CH); Mika Ilvonen, Stäfa (CH); Jaewoo Kim, Stäfa (CH); Mark Schmidt, Stäfa (CH); Daniel Probst, Stäfa (CH); Sahba Aazami, Stäfa (CH)

(73) Assignee: Sonova AG, Stäfa (CH)

(21) Appl. No.: 18/060,281

(22) Filed: Nov. 30, 2022

(51) Int. Cl. H04R 25/00

(52) U.S. Cl. CPC H04R 25/609; H04R 2225/51

(57) ABSTRACT

Small meander line antenna for in-the-ear hearing device, and associated systems and methods are disclosed. In one embodiment, a hearing device includes a housing configured for insertion in an ear canal of a user; and a face plate of the housing configured to carry electronic components of the hearing device. A meander line antenna is operatively coupled to the electronic components of the hearing devices, where conductive traces of the meander line antenna are at least partially shaped as meandering folds that are configured perpendicularly with respect to a principal plane of the face plate.

### FIELD OF THE INVENTION

The inventive technology relates generally to hearing devices, and more particularly relates to methods and apparatuses for antennas of the hearing devices. In particular, the inventive technology relates to dipole antennas having meandering shapes, therefore requiring less space within the confines of the in-the-ear hearing device.

### BACKGROUND

A hearing device is a device supporting hearing activity in general. Some hearing devices (for example “hearing aid devices”, “hearing aids”, “hearing instruments”) are designed to be worn continuously behind the ear or inside the ear for extended periods of time. Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to output sound based on an audio signal which may be communicated, e.g., streamed, by a wire or wirelessly to the hearing device from a streaming source as e.g., a streaming service or an external microphone. A hearing device may also be used to reproduce a sound in a user's ear canal detected by a microphone. The reproduced sound may be amplified to account for a hearing loss, such as in a hearing instrument, or may be output without accounting for a hearing loss, for instance to provide for a faithful reproduction of detected ambient sound and/or to add sound features of an augmented reality in the reproduced ambient sound, such as in a hearable. A hearing device may also provide for a situational enhancement of an acoustic scene, e.g., beamforming and/or active noise cancelling (ANC), with or without amplification of the reproduced sound. A hearing device may also be implemented as a hearing protection device, such as an earplug, configured to protect the user's hearing.

Different types of hearing devices configured to be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device.

FIG. 1 is a schematic view of a hearing device inside the ear canal 10 (also referred to as in-the-ear hearing aid or an ITE hearing aid) in accordance with prior art. The illustrated hearing device is placed between the eardrum 15 and the outside ambient, as a housing 20 of the hearing device laterally contacts the surrounding tissue 16 of the ear canal 10 (e.g., by contacting skin 5). A faceplate of the hearing device faces away of the ear canal. In operation, the hearing device senses the sound arriving at an input transducer (e.g., a microphone port) 27, and re-emits the audio-processed sound 25 through an output transducer or receiver (e.g., a speaker) 26 toward the eardrum 15. An audio processing unit (not shown) receives the signal from the input transducer 27, processes the signal, and outputs the processed signal to the output transducer. The hearing device may be taken out of the ear and re-inserted into the ear using a handle (also referred to as a removal handle or a cable) 30.

Hearing devices are small and delicate instruments that typically include many electronic and metallic components contained in a housing that is small enough to fit at least a portion of the instrument in the ear canal of a human. The compaction of electronic and metallic components in combination with a small size of a housing of the hearing device impose design constraints on the radio frequency antennas that are used in hearing devices that have wireless communication capabilities. Furthermore, as antennas become electrically small compared to the frequency of operation, a trade-off between antenna aperture and radiated efficiency arises. Accordingly, the antennas that are characterized by small size, small power consumption, and good sensitivity are still needed.

### SUMMARY

This summary is provided to introduce a selection of concepts in a simplified form that are further described below in the Detailed Description. This summary is not intended to identify key features of the claimed subject matter.

The inventive technology is directed to antennas used in hearing devices. In some embodiments of the hearing devices, the antenna is preferably miniaturized while preserving efficiency which in turn drives more desirable form factors with efficient power consumption and overall customer satisfaction with wireless connectivity. The inventive technology employs an improved conventional meander line antenna that can achieve required length of conductive traces in a relatively compact space, thus improving overall packaging of the hearing device. Meander line dipole antennas are antennas having a structure including folded conductive patterns that form a folded dipole antenna. Because of the meandering folds of their conductive traces, the meandering line dipole antennas require less space to achieve performance that is comparable with that of a larger, conventional dipole antenna. In different embodiments, the meandering conductive lines of the antenna are shaped as patterns of rectangular, triangular, other polynomial, sinusoidal, spline, or other meandering folds.

In some embodiments, packaging of the meander line antenna may be improved by the meandering folds (also referred to as meandering loops, meandering detours, or meandering deviations) of the conductive traces. These meandering folds may be disposed perpendicularly to the principal plane of the face plate, thus reducing the required size of the face plate. In some embodiments, the smaller size of the meander line antenna may enable a smaller shell of the hearing device, therefore improving a fit of the hearing aid inside the user's ear.

The conductive lines of the meander line antenna may be encapsulated in a flexible printed circuit board (PCB) or deposited on the surface of the PCB for easier handling and packaging inside the hearing device. In some embodiments, the meander line antenna may be held within a trench of a face plate of the hearing device, therefore facilitating better radiative properties and/or easier assembly of the antenna. Furthermore, the PCB that carries meander line antenna may at least partially run along an elevated structure (wall) of the face plate to reduce a seepage of the glue used during the assembly process into the trench of the face plate.

In one embodiment, a hearing device includes: a housing configured for insertion in an ear canal of a user; a face plate of the housing configured to carry electronic components of the hearing device; and a meander line antenna operatively coupled to the electronic components of the hearing devices. The conductive traces of the meander line antenna are at least partially shaped as meandering folds that are configured perpendicularly with respect to a principal plane of the face plate.

In one aspect, the hearing device further includes a printed circuit board that is a flexible printed circuit board, where the meandering folds of the meander line antenna are carried by the printed circuit board.

In one aspect, the printed circuit board includes a first edge that is at least partially housed in a trench of the face plate and a second edge that is opposite from the first edge. The trench follows a perimeter of the face plate.

In one aspect, the first edge of the printed circuit board at least partially follows a bottom of the trench.

In another aspect, the printed circuit board is at least partially aligned against a wall configured in the face plate. The second edge of the printed circuit board is flush with at least a portion of an edge of the wall.

In one aspect, the printed circuit board has a non-uniform width between the first edge and the second edge.

In another aspect, the printed circuit board has a non-uniform thickness.

In one aspect, the meander line antenna is a dipole antenna. Dipole arms of the dipole antenna are electrically coupled through electrical contacts.

In one aspect, the dipole arms of the meander line antenna have different lengths.

In one aspect, the meandering folds include a first plurality of the meandering folds and a second plurality of the meandering folds. The first plurality of the meandering folds is closer to the electrical contacts than the second plurality of the meandering folds. Individual meandering folds of the first plurality of the meandering folds are configured closer to each other than individual meandering folds of the second plurality of the meandering folds.

In another aspect, the individual meandering folds of the first plurality of the meandering folds are smaller than individual meandering folds of the second plurality of the meandering folds.

In one aspect, the meandering folds of the meander line antenna are shaped as a rectangular pattern.

In one aspect, the meandering folds are at least partially housed in a trench of the face plate. The meandering folds are mutually connected by connection sections that at least partially follow a bottom of the trench.

In another aspect, the meandering folds of the meander line antenna are shaped as a triangular pattern.

In one aspect, the wherein the triangular pattern includes connecting sections.

In one aspect, a shape of the meandering folds is selected from a group consisting of a polynomial pattern, a sinusoidal pattern, and a spline pattern.

In one aspect, a spacing among individual traces of the meander line antenna is non-uniform along a span of the meander line antenna.

In one embodiment, a hearing device includes: a housing configured for insertion in an ear canal of a user; a face plate of the housing configured to carry electronic components of the hearing device; and a meander line antenna operatively coupled to the electronic components of the hearing devices. The conductive traces of the meander line antenna are at least partially shaped as meandering folds that are configured perpendicularly with respect to a principal plane of the face plate. The meander line antenna is a dipole antenna having dipole arms of different lengths.

In one aspect, the meandering folds of the meander line antenna are carried by a printed circuit board (PCB) that is a flexible printed circuit board.

In one aspect, the meandering folds of the meander line antenna are shaped as a rectangular pattern or a triangular pattern.

In one aspect, the meandering folds are at least partially housed in a trench of the face plate. Connecting sections of the pattern of rectangular meandering folds at least partially follow a bottom of the trench.

In one aspect, a shape of the meandering folds of the meander line antenna are shaped as a polynomial pattern, a sinusoidal pattern, or a spline pattern.

In one aspect, a spacing among individual meandering folds of the meander line antenna is non-uniform along a span of the meander line antenna.

In one aspect, the printed circuit board includes a first edge that faces the face plate and a second edge that is opposite from the first edge. The printed circuit board has a non-uniform width between the first edge and the second edge. The printed circuit board is at least partially housed in a trench configured in the face plate. The first edge follows a bottom of the trench. The second edge of the printed circuit board is flush with at least a portion of a wall of the face plate.

In one aspect, the meandering folds of the meander line antenna are shaped as a triangular pattern.

In another aspect, the triangular pattern includes connecting sections that are configured parallel to the face plate.

### DESCRIPTION OF THE DRAWINGS

The foregoing aspects and the attendant advantages of the inventive technology will become more readily appreciated as the same become better understood by reference to the following detailed description, when taken in conjunction with the accompanying drawings, wherein:

FIG. 1 is a schematic view of a hearing device inside ear canal in accordance with prior art;

FIG. 2 is an isometric view of a hearing device before final assembly in accordance with an embodiment of the presently disclosed technology;

FIG. 3 is an exploded view of a hearing device shown in FIG. 2;

FIGS. 4A, 4B, 4C and 4D are detailed views of antennas in accordance with embodiments of the presently disclosed technology;

FIG. 5A is an isometric view of an antenna placement inside a hearing device in accordance with an embodiment of the presently disclosed technology;

FIG. 5B is a top plan view of a hearing device in accordance with an embodiment of the presently disclosed technology;

FIG. 5C is a top plan view of an antenna placement inside a hearing device in accordance with an embodiment of the presently disclosed technology;

FIG. 5D is a cross-sectional view D-D of a hearing device shown in FIG. 5A;

FIG. 5E is a cross-sectional view E-E of a hearing device shown in FIG. 5A; and

FIGS. 6A and 6B illustrate a comparison between a hearing device of the prior art and a hearing device in accordance with an embodiment of the presently disclosed technology, respectively.

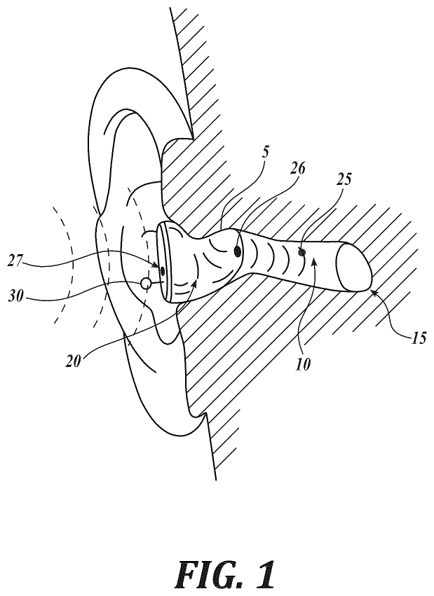

### DETAILED DESCRIPTION

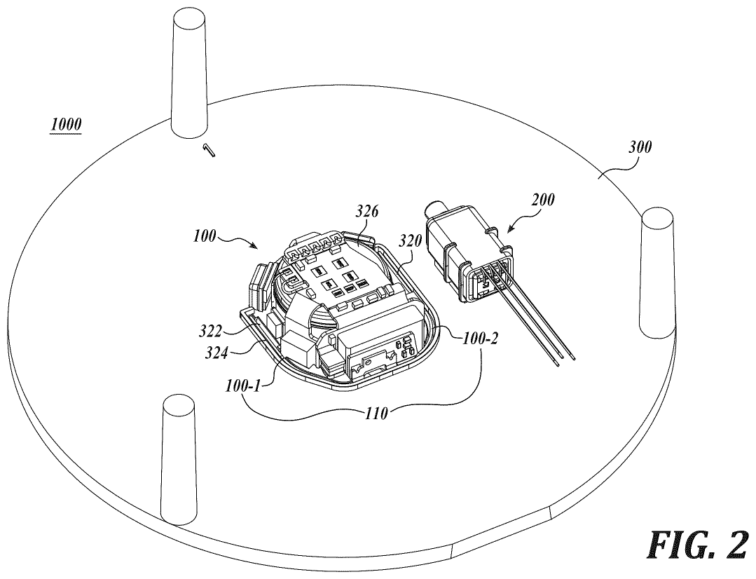

The following disclosure describes various embodiments of systems and associated methods for in-ear acoustic readout of data from a hearing device. A person skilled in the art will also understand that the technology may have additional embodiments, and that the technology may be practiced without several of the details of the embodiments described below with reference to FIGS. 2-6B.

FIG. 2 is an isometric view of a hearing device before final assembly in accordance with an embodiment of the presently disclosed technology. Illustrated hearing device assembly 1000 is carried on a blank faceplate 300 for ease and convenience of manufacturing/assembly process. The blank faceplate may carry pre-assembled electronic components during the manufacturing process. Most of the blank faceplate 300 is eventually removed and discarded, leaving just a portion of the blank faceplate that becomes a faceplate 320.

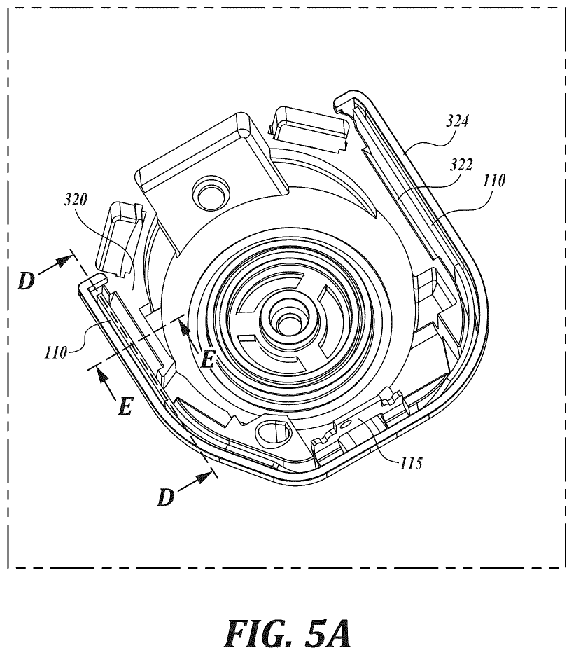

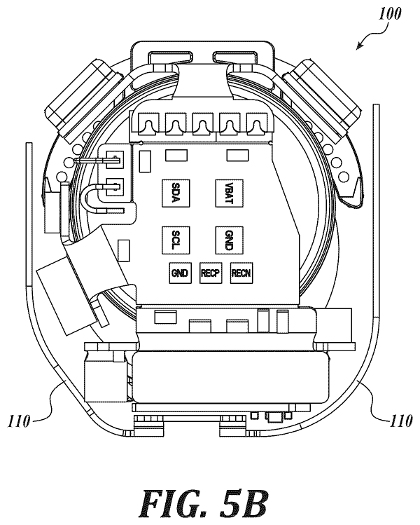

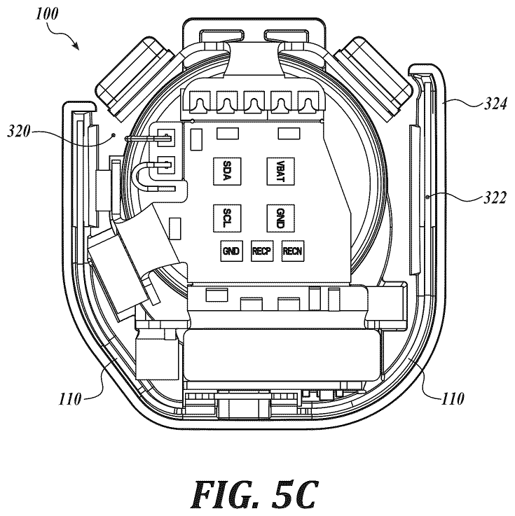

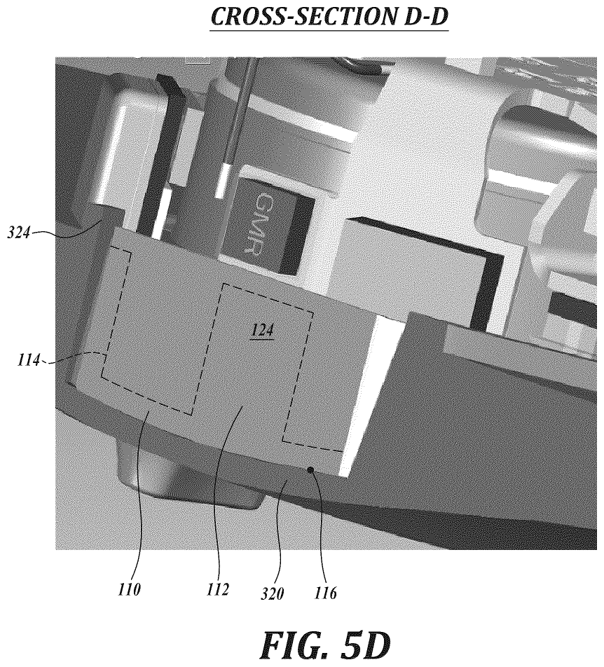

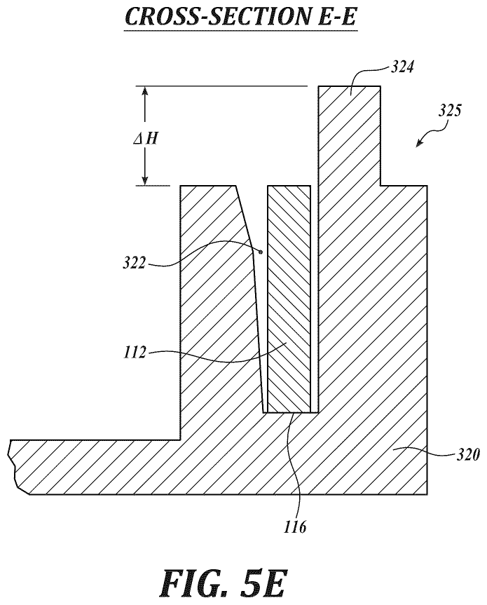

The hearing device assembly 1000 is an assembly that includes a hearing device base 100 with its associated electronics and a receiver 200, these two subassemblies getting mechanically and electrically coupled during later phases of the manufacturing process by placing the receiver 200 on top of the hearing device base 100. The hearing device base 100 includes a meander line antenna 110 that is at least partially held within a trench 322 (also referred to as a channel) and/or a wall 324, as explained in more details with respect to FIG. 5E below. In some embodiments, the meander line antenna 110 is a dipole antenna that includes antenna arms 110-1 and 110-2. The hearing device assembly 1000 may include a battery 326 and other electronic components, passive and active.

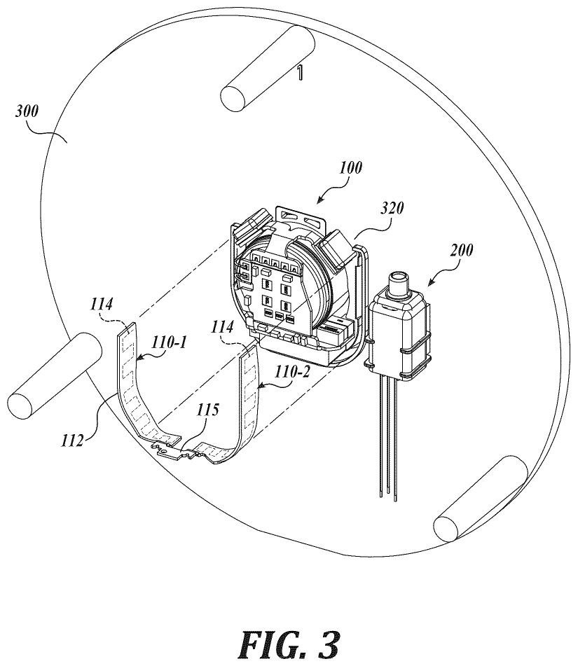

FIG. 3 is an exploded view of a hearing device shown in FIG. 2. In particular, the meander line antenna 110 is illustrated as removed from the faceplate 320. In some embodiments, metal traces 114 of the meander line antenna 110 may be encapsulated in a printed circuit board (PCB) 112. In other embodiments, the traces of the meander line antenna 110 may be printed on the PCB using, for example, direct metal laser sintering (DMLS) technology. In some embodiments, the PCB 112 may be a flexible PCB (a flex circuit) that is suitable for, for example, ease of assembly. The two arms 110-1 and 110-2 of the dipole antenna may be electrically coupled through contacts 115. In some embodiments, the metal traces 114 of the meandering folds of the meander line antenna 110 and the PCB 112 that carries the metal traces run in a plane that is vertical (perpendicular) with respect to the principal plane of the face plate 320 in a trench along an outer edge of the face plate. The principal plane corresponds to the main elongation (i.e., the main plane) of the faceplate. In some embodiments, the principal plane corresponds to the flat inside surface of the faceplate. The relationship between the trench and the PCB is explained further with respect to FIGS. 5A-5E below. The above-described orientation of the meander line antenna may result in a more compact packaging of the antenna with respect to different components of the hearing device, therefore enabling a smaller hearing device and/or a better fit of the hearing device inside the ear canal.

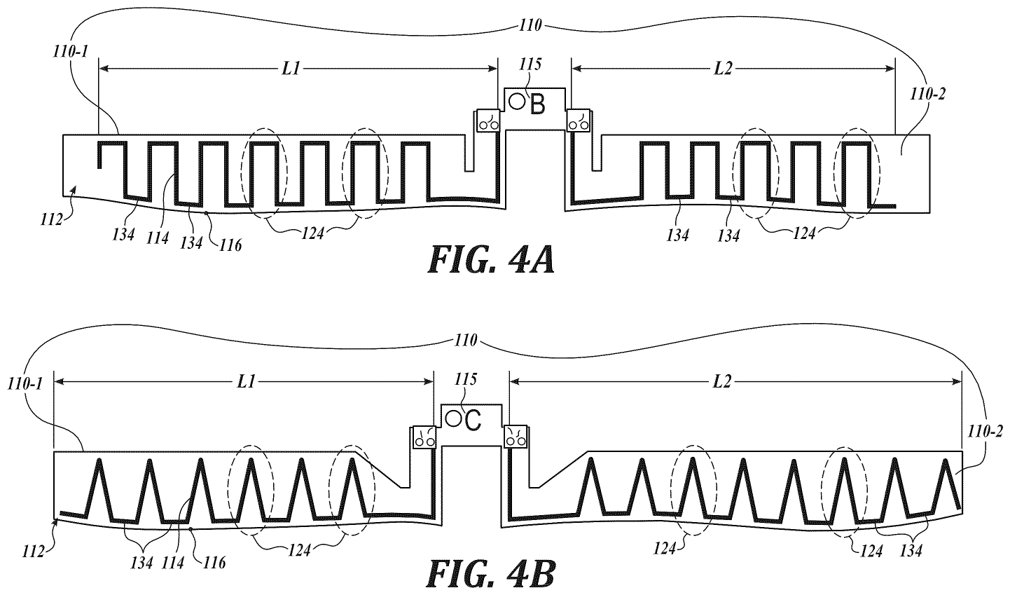

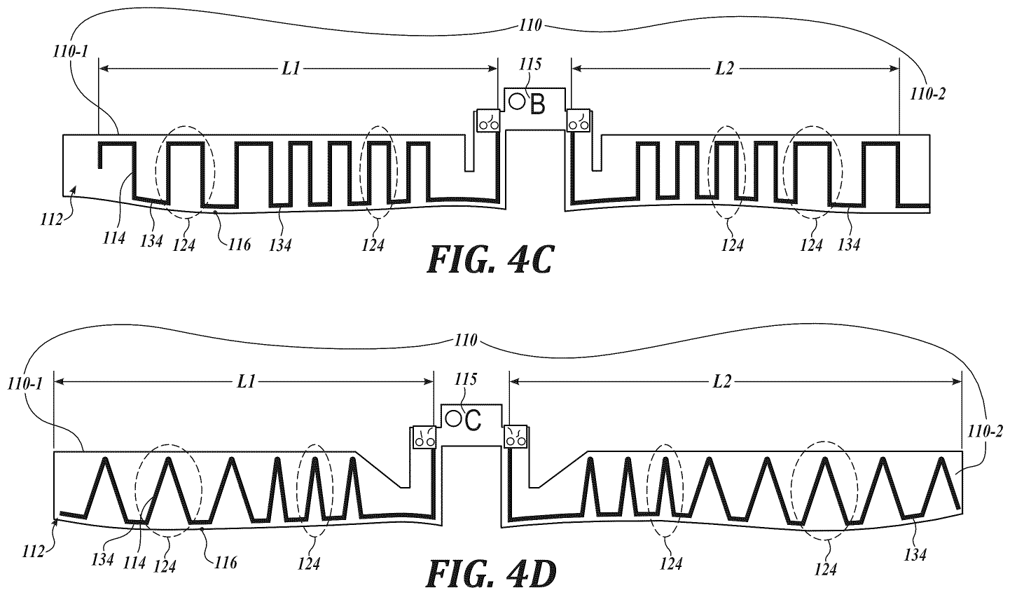

FIGS. 4A and 4B are detailed views of antennas in accordance with embodiments of the presently disclosed technology. In particular, FIG. 4A illustrates a meander line antenna 110 having metal traces 114 that are shaped into patterns that include generally rectangular meandering folds 124, and FIG. 4B illustrates the meander line antenna having metal traces 114 that are shaped into patterns that include generally triangular meandering folds 124. A person of ordinary skill will understand that the illustrated rectangular and rectangular meandering folds 124 are open folds which are mutually connected with connecting sections 134 of the metal traces 114. Thus, a person of ordinary skill will recognize that the rectangular pattern and triangular pattern include open meandering folds in order to form appropriate electrical path of the metal trace 114 of the pattern. Other shapes of the meandering folds 124 are also possible in different embodiments. For example, the meandering folds may take sinusoidal shape, polynomial shape, a spline shape, or other shapes of meandering folds. The meandering folds 124 of the metal traces 114 enable smaller antennas that still possess the required electrical length of the electrical conductor, i.e., the required length of the metal traces 114.

In the context of this specification, the word ‘pattern’ encompasses patterns that include a repetition of shapes of the same size as well as the patterns that include shapes having different sizes. In different embodiments, the shapes (folds) in a pattern may be arranged at same distances or at different distances from each other. In some embodiments, the pattern may refer to a collection of shapes that includes a mixture of one type of shapes and another type of shapes. These different types of shapes may be mixed and arranged next to each other either individually or as groups. Therefore, in different embodiments, individual meandering folds of the pattern of the metal traces may have same size or different sizes.

In general, the lengths L1 and L2 of the two arms of the meandering antenna may be different. The lengths of the conductive traces of the two different arms may also be different. Furthermore, the rectangular or triangular meandering folds of the pattern may be larger in one area of the meander line antenna 110, and smaller (or denser) in another area of the meander line antenna 110. In the embodiments illustrated in FIGS. 4C and 4D, the meandering folds 124 of the pattern are denser (placed closer to each other) and smaller in the proximity of the contacts 115, and sparser (placed further apart) and larger when configured away from the contacts 115. Such non-uniform size/density of the meandering folds of the antenna may be useful to fine-tune impedance of the antenna.

Other antenna-tuning mechanisms (antenna TMs) may be used in different embodiments. For example, the shapes of the meandering folds may be different along the dimension L1 and/or L2. Furthermore, the width of the conductive trace itself may vary.

As illustrated in FIGS. 4C and 4D, the meandering folds 124 may be modified to improve the radiated efficiency of the antenna. For example, the illustrated rectangular pattern of FIG. 4C and the triangular pattern of FIG. 4D include connecting sections 134 that are parallel to the surface of faceplate or that follow a bottom of a trench in the faceplate when assembled. As a result, the connecting sections 134 more closely follow the plane of the faceplate itself, thus further improving the packaging and performance of the antenna.

The antenna arms 110-1 and 110-2 of the meander line antenna 110 are electrically connected through the contacts 115. As explained above, the lengths L1 and L2 of the individual arms of the meander line antenna may have same or different lengths (spans). In some embodiments, different lengths of the individual arms of the antenna, i.e., a non-symmetrical antenna, may result in a more compact packaging of the antenna.

As explained above, the outer edges 116 of the PCB 112 and the connecting sections 134 of the metal traces 114 of the meandering folds may be contoured to better follow the shape of trenches inside the faceplate, thus enabling certain packaging and assembly advantages as described below. For example, the outer edge 116 of the PCB may follow (i.e., be aligned with) the bottom of the trench in the face plate. Thus, the meandering folds 124 in turn also follow the shape of the outer edges 116. In some embodiments, the width of the PCB 112 may be uniform along the entire span of the of the individual arms of the meander line antenna. In some embodiments, the PCB has a thickness that varies along its length. Such a variable thickness of the PCB may be achieved by, for example, increasing the count-of or the thickness-of the core layers to stiffen the PCB. In other embodiments, a variable width of the PCB may set the conductive traces closer to the outer surface of the wall, therefore increasing antenna aperture.

FIG. 5A is an isometric view of an antenna placement inside a hearing device in accordance with an embodiment of the presently disclosed technology. Electronic components and battery are removed from this view to better illustrate placement of the meander line antenna 110 within the trenches and walls of the faceplate 320. Some embodiments of such placement of the meander line antenna are illustrated with respect to cross-sections D and E that are discussed below with respect to FIGS. 5D and 5E, respectively.

FIGS. 5B and 5C are top plan views of a hearing device in accordance with an embodiment of the presently disclosed technology. In particular, FIG. 5B shows the hearing device 100 without the faceplate. In many cases, the illustrated routing of the flex circuit of the meander line antenna 110 enables a relatively compact packaging of the antenna 110 within the hearing device, therefore resulting in an overall smaller hearing device and/or a hearing device having a better fit.

FIG. 5C illustrates a placement of the meander line antenna 110 within the trenches/walls of the faceplate 320. Such placement may ease the assembly process and improve packaging of the meander line antenna 110 within the hearing device. Furthermore, in case of the flex circuit PCB, the trenches 322 and/or walls 324 may improve securing of the meander line antenna 110 to the faceplate 320. Additionally, the wall 324 may prevent or at least reduce the flow of glue into the trench 322 during the process of gluing the upper hearing device subassembly 200 to the faceplate 320. The presence of glue inside the trench 322 may detune the antenna.

FIG. 5D is a detail cross-sectional view D-D of FIG. 5A. The illustrated embodiment includes a pattern of rectangular meandering folds 124 of metal trace 114, but other patterns of meandering folds, for example, triangular, sinusoidal, polynomial shape, spline, etc., are also possible. The meandering folds 124 are configured in a plane that runs vertically with respect to the faceplate 320 of the hearing device. In some embodiments, the edge (contour) 116 of the PCB 112 is shaped to follow the contour of the face plate 320. As explained above, by having the outline of the PCB 112 follow the contour (perimeter) of the faceplate 320, the conductive antenna traces as brought closer to the surface of the faceplate, therefore improving a radiated efficiency of the antenna, because the antenna is further out of the ear canal and there is more separation between the antenna and the internal metallic structures of the hearing device.

FIG. 5E is a cross-sectional view E-E of a hearing device shown in FIG. 5A. In some embodiments, after aligning the edge 116 of the flex circuit 112 with the bottom of the trench (channel) 322, the opposite edge of the flex circuit 112 aligns with the upper edge of the trench 322. Therefore, an assembler may verify a proper assembly of the flex circuit 112 either visually or, for example, by placing her finger on the two outer edges of the flex circuit 112 and the trench 322, and verifying that the two edges are at the same height (flush).

In some embodiments, the flex circuit 112 is at least partially located into its proper place based on a location of the wall 324. For example, the outer edge of the wall 324 may be offset from the outer edge of the trench 322 by a height difference ΔH. Therefore, the assembler may additionally verify the proper assembly of the flex circuit 112 by verifying the height difference ΔH. In other embodiments, the wall 324 may be configured such that the flex circuit, when properly assembled, reaches the outer edge of the wall 324. The wall 324 may include a ledge 325, which creates a glue-surface on the outer side of the wall 324. During the assembly process, the shell of the hearing aid can be glued to the ledge 325.

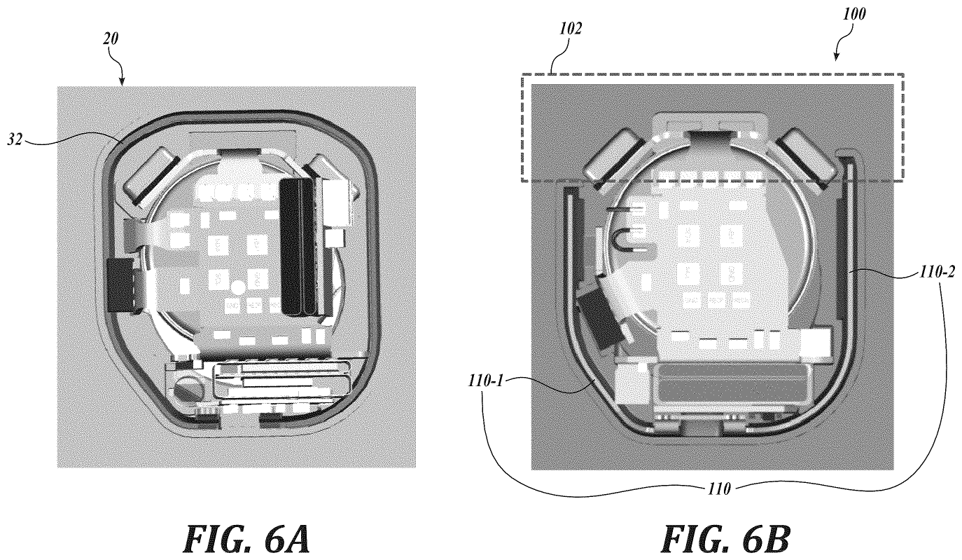

FIGS. 6A and 6B illustrate a comparison between a conventional hearing device (FIG. 6A) and a hearing device in accordance with an embodiment of the presently disclosed technology (FIG. 6B). In particular, a dipole antenna 32 of the prior art as shown in FIG. 6A generally requires more space than does the meander line antenna 100 having an equivalent performance (e.g., an equivalent overall length of metal traces). A reduction in the space needed for the meander line antenna is marked by a rectangle 102, which generally corresponds to overall smaller space required for the housing of the hearing device of FIG. 6B. In some embodiments, such smaller size of the housing of the hearing device enables a better fit of the hearing devices. As a non-limiting example, the inventors have found that a hearing device having an inventive dipole antenna of FIG. 6B has an improved fit in comparison to the dipole antenna of the prior art of FIG. 6A.

The terms used in the embodiments of the present disclosure are merely for the purpose of describing specific embodiment, rather than limiting the present disclosure. The terms “a”, “an”, “the”, and “said” in a singular form in the embodiments of the present disclosure and the attached claims are also intended to include plural forms thereof, unless noted otherwise.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Such computers, controllers and data processors may include a non-transitory computer-readable medium with executable instructions. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the term “about,” approximately” and similar means +/−5% of the stated value.

For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

What is claimed is:

1. A hearing device, comprising:
a housing configured for insertion in an ear canal of a user;
a face plate of the housing configured to carry electronic components of the hearing device; and
a meander line antenna operatively coupled to the electronic components of the hearing devices, wherein conductive traces of the meander line antenna are at least partially shaped as meandering folds that are configured perpendicularly with respect to a principal plane of the face plate.

2. The hearing device of claim 1, further comprising a printed circuit board that is a flexible printed circuit board, wherein the meandering folds of the meander line antenna are carried by the printed circuit board.

3. The hearing device of claim 2, wherein the printed circuit board comprises a first edge that is at least partially housed in a trench of the face plate and a second edge that is opposite from the first edge, and wherein the trench follows a perimeter of the face plate.

4. The hearing device of claim 3, wherein the first edge of the printed circuit board is aligned with a bottom of the trench.

5. The hearing device of claim 4, wherein the printed circuit board is at least partially aligned against a wall configured in the face plate, and wherein the second edge of the printed circuit board is flush with at least a portion of an edge of the wall.

6. The hearing device of claim 3, wherein the printed circuit board has a non-uniform width between the first edge and the second edge.

7. The hearing device of claim 2, wherein the printed circuit board has a non-uniform thickness.

8. The hearing device of claim 1, wherein the meander line antenna is a dipole antenna, and wherein dipole arms of the dipole antenna are electrically coupled through electrical contacts.

9. The hearing device of claim 8, wherein the dipole arms of the meander line antenna have different lengths.

10. The hearing device of claim 8, wherein the meandering folds comprise a first plurality of the meandering folds and a second plurality of the meandering folds,
wherein the first plurality of the meandering folds is closer to the electrical contacts than the second plurality of the meandering folds, and
wherein individual meandering folds of the first plurality of the meandering folds are configured closer to each other than individual meandering folds of the second plurality of the meandering folds.

11. The hearing device of claim 10, wherein the individual meandering folds of the first plurality of the meandering folds are smaller than individual meandering folds of the second plurality of the meandering folds.

12. The hearing device of claim 1, wherein the meandering folds of the meander line antenna are shaped as a rectangular pattern.

13. The hearing device of claim 12, wherein the meandering folds are at least partially housed in a trench of the face plate, and mutually connected by connecting sections that at least partially follow a bottom of the trench.

14. The hearing device of claim 1, wherein the meandering folds of the meander line antenna are shaped as a triangular pattern.

15. The hearing device of claim 14, wherein the triangular pattern includes connecting sections.

16. The hearing device of claim 1, wherein a shape of the meandering folds is selected from a group consisting of a polynomial pattern, a sinusoidal pattern, and a spline pattern.

17. The hearing device of claim 1, wherein a spacing among individual traces of the meander line antenna is non-uniform along a span of the meander line antenna.

18. A hearing device, comprising:
a housing configured for insertion in an ear canal of a user;
a face plate of the housing configured to carry electronic components of the hearing device; and
a meander line antenna operatively coupled to the electronic components of the hearing devices, wherein conductive traces of the meander line antenna are at least partially shaped as meandering folds that are configured perpendicularly with respect to a principal plane of the face plate, and wherein the meander line antenna is a dipole antenna having dipole arms of different lengths.

19. The hearing device of claim 18, wherein the meandering folds of the meander line antenna are carried by a printed circuit board (PCB) that is a flexible printed circuit board.

20. The hearing device of claim 18, wherein the meandering folds of the meander line antenna are shaped as a rectangular pattern or a triangular pattern.

21. The hearing device of claim 18, wherein the meandering folds are at least partially housed in a trench of the face plate, and wherein connecting sections of the rectangles of the meandering folds at least partially follow a bottom of the trench.

22. The hearing device of claim 18, wherein the meandering folds of the meander line antenna are shaped as a polynomial pattern, a sinusoidal pattern, or a spline pattern.

23. The hearing device of claim 18, wherein a spacing among individual meandering folds of the meander line antenna is non-uniform along a span of the meander line antenna.

24. The hearing device of claim 19, wherein the printed circuit board comprises a first edge that faces the face plate and a second edge that is opposite from the first edge, wherein the printed circuit board has a non-uniform width between the first edge and the second edge, wherein the printed circuit board is at least partially housed in a trench configured in the face plate, wherein the first edge follows a bottom of the trench, and wherein the second edge of the printed circuit board is flush with at least a portion of a wall of the face plate.
